(19) United States
(12) Patent Application Publication
(10) Pub. No.: US 2010/0033665 A1
(43) Pub. Date: Feb. 11, 2010

(54) LIQUID CRYSTAL DISPLAY DEVICE

(76) Inventors: Kohei Tanaka, Osaka (JP); Keisuke Yoshida, Osaka (JP); Mutsumi Nakajima, Osaka (JP)

Correspondence Address: BIRCH STEWART KOLASCH & BIRCH, PO BOX 747, FALLS CHURCH, VA, 22040-0747, US

(21) Appl. No.: 12/518,818

(22) PCT Filed: Dec. 11, 2007
(86) PCT No.: PCT/JP2007/073856

§ 371 Date: Jun. 11, 2009

(30) Foreign Application Priority Data
Dec. 12, 2006 (JP) 2006-334724

(51) Int. Cl. G02F 1/1343

(52) U.S. Cl. 349/139

(57) ABSTRACT

There is provided a liquid crystal display device that can suppress a reduction in picture quality of a display image that is caused when one of adjacent pixels is affected by a fluctuation in electric potential of the other pixel. A liquid crystal display device including an array substrate that includes pixel electrodes and a plurality of TFTs that drive the pixel electrodes is used. Each of the TFTs is arranged in a region directly below one of the pixel electrodes that is different from and adjacent to the pixel electrode to be driven thereby. Further, the TFT includes a silicon film provided with a diffusion layer, as well as a gate electrode provided on the silicon film via an insulating film. The silicon film is formed so as to range from a region directly below the pixel electrode to be driven by the TFT to the region directly below the pixel electrode. Further, a portion of the silicon film that is in the region directly below the pixel electrode to be driven by the TFT is connected electrically to the pixel electrode to be driven by the TFT.

### TECHNICAL FIELD

The present invention relates to a liquid crystal display device, and in particular to a liquid crystal display device that can suppress the occurrence of horizontal stripes in a display image.

### BACKGROUND ART

Conventionally, in a liquid crystal display device capable of performing a color display, one pixel is composed of three sub-pixels corresponding to three primary colors of red, green, and blue. Each of the sub-pixels is provided with pixel components such as a TFT and a pixel electrode. The sub-pixels are arranged in the following known manner: a stripe arrangement in which the sub-pixels of the same color are disposed in a vertical direction, a delta arrangement in which the sub-pixels of the same color are disposed in an oblique direction, or the like.

Among them, the stripe arrangement leads to a display of sharply defined graphics, characters, and the like, and thus it is suited for use in a display device for OA use. On the other hand, the delta arrangement leads to a display of an image that is close to what is seen with the naked eye, as compared with the stripe arrangement. Thus, the delta arrangement is suited for use in a display device for displaying a screen image for video and television broadcasting.

The following is a description of a conventional liquid crystal display device, with reference to FIGS. 5 to 7 (see Patent Document 1, for example). In the example shown in FIGS. 5 to 7, sub-pixels are arranged in a delta pattern. FIG. 5 is a plan view showing a layout of pixel electrodes and source bus lines in the conventional liquid crystal display device. In FIG. 5, only a top surface of an array substrate composing the liquid crystal display device is shown.

Since the liquid crystal display device shown in FIG. 5 adopts the delta arrangement, pixel electrodes 32 that respectively compose a plurality of the sub-pixels are arranged such that a regular triangle is formed when centers of the three adjacent pixel electrodes are connected to one another. There are three types of the pixel electrodes 32 according to the color of corresponding color filters. Since the delta arrangement is adopted, the pixel electrodes 32 whose corresponding color filters are of the same color are disposed in an oblique direction.

In the delta arrangement, unlike the stripe arrangement, the pixel electrodes 32 are not aligned in a vertical direction, and accordingly source bus lines 38 are formed in a crank shape. There are three types of the source bus lines 38 according to the type of the pixel electrodes 32, i.e., R source bus lines 38R for writing data into the red pixel electrodes 32, G source bus lines 38G for writing data into the green pixel electrodes 32, and B source bus lines 38B for writing data into the blue pixel electrodes 32. In FIG. 5, the source bus lines are indicated by different hatching according to their type.

Next, a specific structure of the array substrate shown in FIG. 5 will be described with reference to FIGS. 6 and 7. FIG. 6 is a plan view showing a specific configuration of a part of the liquid crystal display device shown in FIG. 5. FIG. 7 is a cross-sectional view showing the specific configuration of the part of the liquid crystal display device shown in FIG. 5. In FIGS. 6 and 7, only the array substrate composing the liquid crystal display device is shown. The cross section shown in FIG. 7 is taken along a line B-B′ in FIG. 6. Insulating members are not shown in FIG. 6 and not indicated by hatching in FIG. 7.

As shown in FIGS. 6 and 7, respective pixel electrodes 32a to 32e are driven by corresponding TFT's 33. In the example shown in FIGS. 6 and 7, only the TFT 33 corresponding to the pixel electrode 32a is shown. The TFT 33 includes a silicon film 34 formed on a glass substrate 46, and a gate electrode 36 formed on the silicon film 34 via an insulating film 35.

In the silicon film 34, except for a portion directly below the gate electrode 36, a diffusion layer that serves as a source region or a drain region is formed. The gate electrode 36 is a wiring branched from a gate bus line 37. The gate electrode 36 and the gate bus line 37 are formed of a GE metal on the insulating film 35. Note here that the GE metal refers to a metal material formed of a single layer structure of a high melting point conductive material such as tungsten, molybdenum, and tantalum, or a laminated structure of these materials. Further, in the same layer as the gate bus line 37, a CS bus line 40 for forming a storage capacity also is formed of the GE metal similarly. The gate electrode 36, the gate bus line 37, and the CS bus line 40 are covered with an interlayer insulating film 41.

Each of the source bus lines 38 is formed of a SE metal on the interlayer insulating film 41. The source bus line 38 and the TFT 33 are connected to each other by a contact 44 penetrating the interlayer insulating film 41 and the insulating film 35. In the same layer as the source bus line 38, a connection wiring 39 for connecting the TFT 33 and the pixel electrode 32a is formed of the SE metal similarly. The connection wiring 39 and the TFT 33 also are connected to each other by a contact 43 penetrating the interlayer insulating film 41 and the insulating film 35.

A resin layer 42 is formed on the interlayer insulating film 41 so as to cover the source bus line 38 and the connection wiring 39. The pixel electrodes 32a to 32e are formed of an ITO film on the rein layer 42. In FIG. 7, the pixel electrode 32a is connected to the connection wiring 39 by a through hole 45. The through hole 45 is obtained by forming a conductive film on a wall surface of an open hole provided in the resin layer 42.

As described above, in the example shown in FIGS. 6 and 7, the pixel electrode 32a and the corresponding TFT 33 are connected to each other via the through hole 45, the connection wiring 39, and the contact 43. However, the TFT 33 for driving the pixel electrode 32a is arranged directly below the pixel electrode 32b different from the pixel electrode 32a. Further, the gate bus line 37 for driving the TFT 33 also is arranged directly below the pixel electrode 32b different from the pixel electrode 32a.

This layout is adopted in order to suppress an increase in parasitic capacitance (Cgd) between the pixel electrode 32a to be driven by the TFT 33 and the gate bus line 37, thereby avoiding an increase in capacity of the gate bus line that causes a gate signal waveform to be blunted.
Patent Document 1: JP 8(1996)-240812A

### DISCLOSURE OF INVENTION

### Problem to be Solved by the Invention

Meanwhile, as shown in FIGS. 5 to 7, when the TFT for driving the pixel electrode 32a is arranged directly below the different pixel electrode 32b, a parasitic capacitance Cppud is generated between the connection wiring 39 for connecting the pixel electrode 32a to the TFT 33 and the different pixel electrode 32b (see FIG. 7).

Further, the liquid crystal display device shown in FIGS. 5 to 7 is driven by a 1H-line inversion driving method, and horizontal-line scanning is performed from top to bottom. Accordingly, data written into the sub-pixel of the pixel electrode 32a and data written into the sub-pixel of the pixel electrode 32b provided one horizontal line below the pixel electrode 32a are of opposite polarity. As a result, the sub-pixel composed of the pixel electrode 32a is affected by a fluctuation in electric potential in the pixel electrode 32b provided one horizontal line below the pixel electrode 32a via the parasitic capacitance Cppud.

For example, attention is given to the green sub-pixels shown in FIG. 5. The green sub-pixel in the center horizontal line in FIG. 5 forms the parasitic capacitances Cppud with the red sub-pixels. On the other hand, the green sub-pixels in the upper horizontal line or the lower horizontal line in FIG. 5 form the capacitances Cppud with the blue sub-pixels.

Thus, when a writing potential for the red sub-pixels is different from that for the blue sub-pixels, the effect of a fluctuation in electric potential on the green sub-pixels varies in each horizontal line, resulting in the occurrence of horizontal stripes. In particular, they are observed noticeably in the case of an intermediate gradation display.

The present invention is to solve the above-described problem, and it is an object of the present invention to provide a liquid crystal display device that can suppress a reduction in picture quality of a display image that is caused when one of the adjacent pixels is affected by a fluctuation in electric potential of the other pixel.

### Means for Solving Problem

In order to achieve the above-mentioned object, a liquid crystal display device according to the present invention includes an array substrate that includes a plurality of pixel electrodes and a plurality of active elements that drive the plurality of pixel electrodes. Each of the plurality of active elements is arranged in a region directly below one of the pixel electrodes that is different from and adjacent to the pixel electrode to be driven thereby, and includes a silicon film provided with a diffusion layer, as well as a gate electrode provided on the silicon film via an insulating film. The silicon film is formed so as to range from a region directly below the pixel electrode to be driven by the active element composed of the silicon film to the region directly below the different pixel electrode, and a portion of the silicon film that is in the region directly below the pixel electrode to be driven by the active element is connected electrically to the pixel electrode to be driven by the active element.

### Effects of the Invention

Also in the liquid crystal display device of the present invention, the active element is located directly below the pixel electrode not to be driven thereby as in the conventional example. However, a portion of the silicon film composing the active element that is in the region directly below the pixel electrode to be driven is connected to the pixel electrode to be driven. Thus, in the present invention, a parasitic capacitance Cppud is generated between the silicon film in the lower layer composing the active element and the pixel electrode not to be driven. Accordingly, the parasitic capacitance Cppud is extremely smaller than that in the conventional example. Consequently, according to the present invention, it is possible to allow one of the adjacent pixels to be less subject to a fluctuation in electric potential of the other pixel, thereby suppressing a reduction in picture quality of a display image.

### BRIEF DESCRIPTION OF DRAWINGS

FIG. 1 is a plan view showing a specific configuration of a part of a liquid crystal display device according to Embodiment 1 of the present invention.

FIG. 2 is a cross-sectional view showing the specific configuration of the part of the liquid crystal display device according to Embodiment 1 of the present invention.

FIG. 3 is a plan view showing a specific configuration of a part of a liquid crystal display device according to Embodiment 2 of the present invention.

FIG. 4 is a plan view showing a specific configuration of a part of a liquid crystal display device according to Embodiment 3 of the present invention.

FIG. 5 is a plan view showing a layout of pixel electrodes and source bus lines in a conventional liquid crystal display device.

FIG. 6 is a plan view showing a specific configuration of a part of the liquid crystal display device shown in FIG. 5.

FIG. 7 is a cross-sectional view showing the specific configuration of the part of the liquid crystal display device shown in FIG. 5.

### DESCRIPTION OF THE INVENTION

A liquid crystal display device according to the present invention includes an array substrate that includes a plurality of pixel electrodes and a plurality of active elements that drive the plurality of pixel electrodes. Each of the plurality of active elements is arranged in a region directly below one of the pixel electrodes that is different from and adjacent to the pixel electrode to be driven thereby, and includes a silicon film provided with a diffusion layer, as well as a gate electrode provided on the silicon film via an insulating film. The silicon film is formed so as to range from a region directly below the pixel electrode to be driven by the active element composed of the silicon film to the region directly below the different pixel electrode, and a portion of the silicon film that is in the region directly below the pixel electrode to be driven by the active element is connected electrically to the pixel electrode to be driven by the active element.

In the above-described liquid crystal display device according to the present invention, the array substrate can include, on the silicon film, a second insulating film covering the insulating film and the gate electrode, as well as a resin layer covering the second insulating film, and the plurality of pixel electrodes can be formed on the resin layer. The silicon film and the pixel electrode can be connected electrically via a first conductive path penetrating the insulating film and the second insulating film, a second conductive path penetrating the resin layer, and a wiring provided on the second insulating film.

In the above-described liquid crystal display device according to the present invention, sub-pixels including the pixel electrodes may be arranged in a delta pattern, or alternatively sub-pixels including the pixel electrodes may be arranged in a stripe pattern.

### Embodiment 1

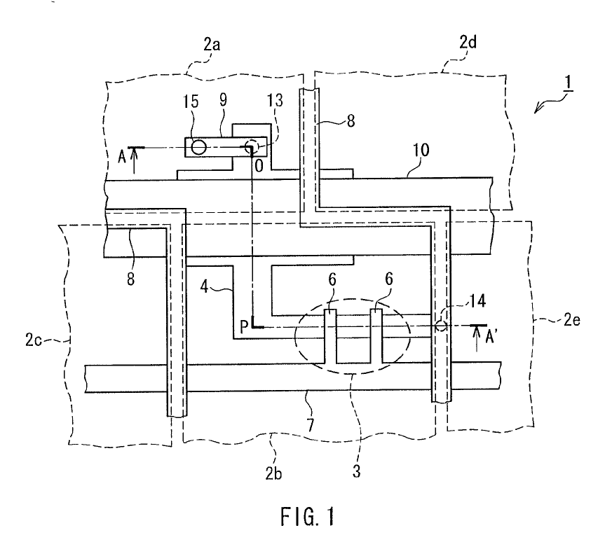

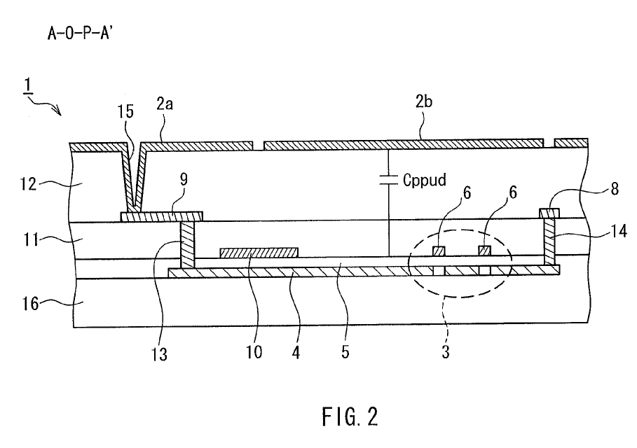

Hereinafter, a liquid crystal display device according to Embodiment 1 of the present invention will be described with reference to FIGS. 1 and 2. FIG. 1 is a plan view showing a specific configuration of a part of the liquid crystal display device according to Embodiment 1 of the present invention. FIG. 2 is a cross-sectional view showing the specific configuration of the part of the liquid crystal display device according to Embodiment 1 of the present invention.

The liquid crystal display device according to Embodiment 1 is configured such that a liquid crystal layer is sandwiched between an array substrate and a facing substrate. In FIGS. 1 and 2, only an array substrate 1 composing the liquid crystal display device is shown. In FIG. 1, insulating members are not shown. FIG. 2 shows a cross section taken along a line A-O-P-A′ in FIG. 1.

The array substrate 1 composing the liquid crystal display device according to Embodiment 1 includes a plurality of pixel electrodes corresponding respectively to a plurality of sub-pixels, and a plurality of active elements for driving the respective pixel electrodes. Each of the active elements is a TFT (Thin Film Transistor) 3. In FIG. 1, only a part of the plurality of pixel electrodes, i.e., pixel electrodes 2a to 2e, and a part of the plurality of TFTs 3, i.e., the TFT 3 for driving the pixel electrode 2a, are shown.

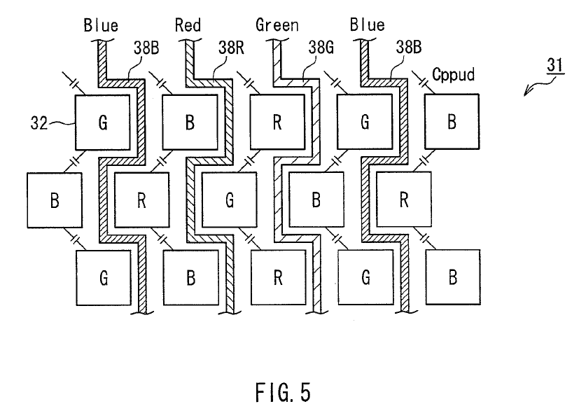

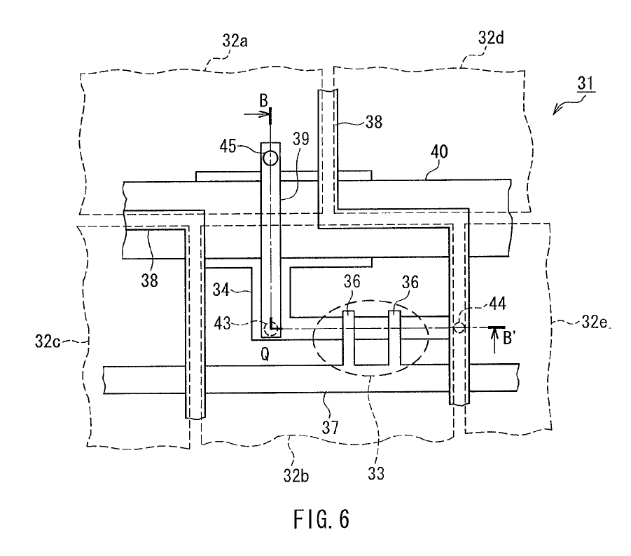

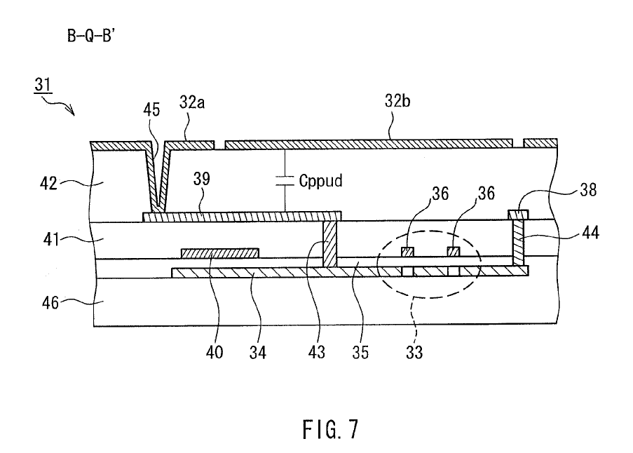

Also in Embodiment 1, the sub-pixels, each composed of the pixel electrode, a color filter (not shown), and the like, are arranged in a delta pattern (see FIG. 5) as in the example (conventional example) shown in FIGS. 5 to 7 in Background Art. Each of the TFTs is arranged in a region directly below the pixel electrode different from and adjacent to the pixel electrode to be driven thereby. More specifically, as shown in FIGS. 1 and 2, the TFT 3 is arranged in a region directly below the pixel electrode 2b that is disposed one horizontal line below a line in which the pixel electrode 2a (to be driven thereby) is disposed.

Further, as shown in FIGS. 1 and 2, the TFT 3 includes a silicon film 4 provided with a diffusion layer, and a gate electrode 6. The silicon film 4 is formed so as to range from a region directly below the pixel electrode 2a to the region directly below the pixel electrode 2b since the TFT 3 is arranged in the region directly below the pixel electrode 2b not to be driven thereby, as described above.

In Embodiment 1, in the silicon film 4, except for a portion directly below the gate electrode 6, the diffusion layer is formed by introducing impurities by ion implantation. The silicon film 4 is formed on a principal surface of a glass substrate 16 serving as a base substrate of the array substrate 1. Further, a first insulating film 5 is formed on the silicon film 4 so as to cover the same. On the first insulating film 5, the gate electrode 6, a gate bus line 7, and a Cs bus line 10 are formed. A portion of the first insulating film 5 that is in contact with the gate electrode 6 functions as a gate insulating film.

The gate electrode 6, which is a wiring branched from the gate bus line 7, is formed by the same process and at the same time as the gate bus line 7. The Cs bus line 10 also is formed by the same process and at the same time as the gate bus line 7. More specifically, initially, a GE metal layer is formed on the first insulating film 5, and a resist pattern that covers a region for forming the gate electrode 6, the gate bus line 7, and the Cs bus line 10 is formed thereon. Then, etching is carried out by using the resist pattern as a mask, thereby forming the gate electrode 6, the gate bus line 7, and the Cs bus line 10.

A second insulating film 11 is formed on the gate electrode 6, the gate bus line 7, and the Cs bus line 10 so as to cover the same and the first insulating film 5. On the second insulating film 11, a source bus line 8 and connection wirings 9 for connecting the TFTs and the pixel electrodes to be driven thereby are formed. In FIGS. 1 and 2, only the connection wiring 9 for connecting the TFT 3 and the pixel electrode 2a is shown. Since the delta arrangement is adopted, the source bus line 8 is formed in a crank shape.

The source bus line 8 and the connection wiring 9 are formed by the same process and at the same time by using a SE metal. Note here that the SE metal refers to a low-resistance conductive material such as aluminum, copper, gold, and silver, or a mixture of such a material and a slight amount of silicon. Further, the SE metal includes a structure in which the above-mentioned low-resistance conductive material such as aluminum and a barrier metal such as titanium and titanium nitride are laminated. The source bus line 8 and the connection wiring 9 are formed by forming a SE metal layer and forming a resist pattern, followed by etching, similarly to the gate bus line 7 and the like. Further, contacts 13 and 14 penetrating the first insulating film 5 and the second insulating film 11 are formed as conductive paths in a thickness direction of the array substrate. The connection wiring 9 is connected to the silicon film 4 composing the TFT 3 by the contact 13. The source bus line 8 is connected to the silicon film 4 by the contact 14.

A resin layer 12 is formed on the second insulating film 11 so as to cover the second insulating film 11, the source bus line 8, and the connection wiring 9. The pixel electrodes 2a to 2e are formed on the resin layer 12. Each of the pixel electrodes 2a to 2e is connected to the corresponding connection wiring 9 by a through hole (conductive path) 15 penetrating the resin layer 12. This structure ensures an electrical connection between the TFT and the pixel electrode to be driven thereby.

As described above, also in Embodiment 1, the TFT 3 is located directly below the pixel electrode 2b not to be driven thereby, and the TFT 3 and the pixel electrode 2a to be driven thereby are connected by the contact 13, the connection wiring 9, and the through hole 15 as in the conventional example. However, Embodiment 1 is different from the conventional example in the following point.

As shown in FIGS. 1 and 2, in Embodiment 1, unlike the conventional example, the contact 13 for connecting the connection wiring 9 and the TFT 3 is formed in the region directly below the pixel electrode 2a to be driven. A portion of the silicon film 4 composing the TFT 3 that is in the region directly below the pixel electrode 2a is connected electrically to the pixel electrode 2a. Accordingly, unlike the conventional example, it is not necessary for the connection wiring 9 for connecting the pixel electrode 2a and the TFT 3 to be formed so as to range over the region directly below the pixel electrode 2b not to be driven, and the connection wiring 9 is formed only in the region directly below the pixel electrode 2a to be driven.

Thus, in Embodiment 1, unlike the conventional example, a parasitic capacitance Cppud is generated between the silicon film 4 composing the TFT 3 and the pixel electrode 2b. Since the silicon film 4 is provided below the connection wiring 9, the parasitic capacitance Cppud is extremely smaller than that in the conventional example. Consequently, according to Embodiment 1, it is possible to suppress effectively a reduction in picture quality of a display image that is caused when one of the adjacent pixels is affected by a fluctuation in electric potential of the other pixel.

### Embodiment 2

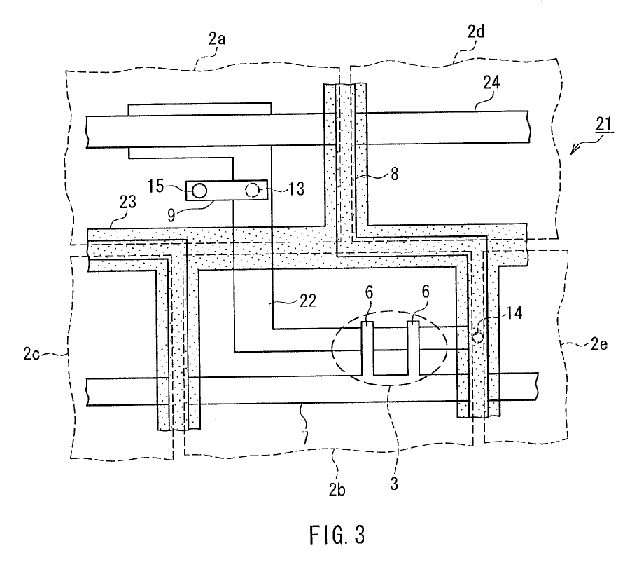

Next, a liquid crystal display device according to Embodiment 2 of the present invention will be described with reference to FIG. 3. FIG. 3 is a plan view showing a specific configuration of a part of the liquid crystal display device according to Embodiment 2 of the present invention. Also in FIG. 3, only an array substrate 21 composing the liquid crystal display device is shown, and insulating members are not shown, as in FIG. 1. In FIG. 3, the same reference numerals as those in FIG. 1 denote the same members as those in FIG. 1.

The liquid crystal display device according to Embodiment 2 also is configured such that a liquid crystal layer (not shown) is sandwiched between the array substrate 21 and a facing substrate (not shown) similarly to the liquid crystal display device according to Embodiment 1. However, Embodiment 2 is different from Embodiment 1 in that a lattice-like light-shielding film (black matrix) 23 is provided in a portion corresponding to a boundary between pixel electrodes on the facing substrate.

Further in Embodiment 2, a Cs bus line 24 is formed in a region directly below a corresponding pixel electrode, unlike the Cs bus line 10 shown in FIGS. 1 and 2 in Embodiment 1 that is formed on a boundary between the pixels. In accordance with the shape of the Cs bus line 24, a silicon film 22 composing the TFT 3 has a pattern shape different from that in Embodiment 1. Except for the above-described points, the liquid crystal display device according to Embodiment 2 has the same configuration as that of the liquid crystal display device according to Embodiment 1.

With this configuration, according to Embodiment 2, a region in which the Cs bus line 24 and the source bus line 8 overlap each other becomes smaller, and accordingly a parasitic capacitance (Cscsx) generated therebetween also becomes smaller than those in Embodiment 1. As a result, capacities of the source bus line and the Cs bus line are reduced, and accordingly power consumption also is reduced as compared with Embodiment 1. Further, it is also possible to suppress a reduction in display quality due to an increase in the capacities of the source bus line and the Cs bus line.

Also in Embodiment 2, the contact 13 for connecting the connection wiring 9 and the TFT 3 is formed in a region directly below the pixel electrode 2a to be driven, similarly to Embodiment 1. Further, a portion of the silicon film 22 composing the TFT 3 that is in the region directly below the pixel electrode 2a is connected electrically to the pixel electrode 2a. Consequently, also in Embodiment 2, it is possible to suppress effectively a reduction in picture quality of a display image that is caused when one of the adjacent pixels is affected by a fluctuation in electric potential of the other pixel.

### Embodiment 3

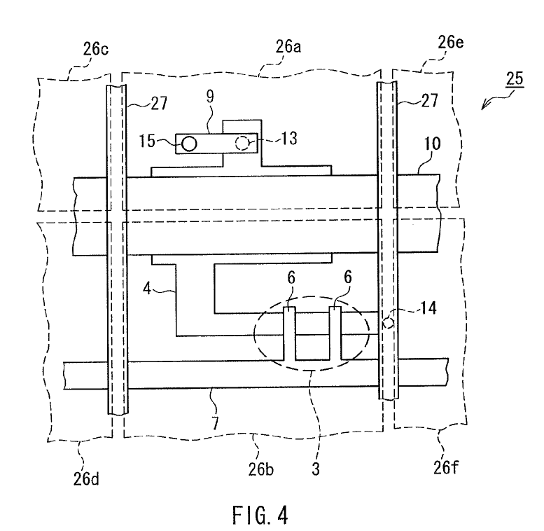

Next, a liquid crystal display device according to Embodiment 3 of the present invention will be described with reference to FIG. 4. FIG. 4 is a plan view showing a specific configuration of a part of the liquid crystal display device according to Embodiment 3 of the present invention. Also in FIG. 4, only an array substrate 25 composing the liquid crystal display device is shown, and insulating members are not shown, as in FIG. 1. In FIG. 4, the same reference numerals as those in FIG. 1 denote the same members as those in FIG. 1.

The liquid crystal display device according to Embodiment 3 also is configured such that a liquid crystal layer (not shown) is sandwiched between the array substrate 25 and a facing substrate (not shown) similarly to the liquid crystal display device according to Embodiment 1. However, Embodiment 3 is different from Embodiment 1 in that sub-pixels are arranged in a stripe pattern and that a source bus line 27 is formed linearly. Further, a plurality of pixel electrodes are arranged in a square matrix pattern. In FIG. 4, only a part of the plurality of pixel electrodes, i.e., pixel electrodes 26a to 26f, are shown.

As described above, since the liquid crystal display device according to Embodiment 3 adopts the stripe arrangement, it can display sharply defined graphics, characters, and the like as compared with Embodiments 1 and 2. Thus, the liquid crystal display device according to Embodiment 3 is better suited for OA applications than the liquid crystal display devices according to Embodiments 1 and 2.

Also in Embodiment 3, the contact 13 for connecting the connection wiring 9 and the TFT 3 is formed in a region directly below the pixel electrode 26a to be driven, similarly to Embodiment 1. Further, a portion of the silicon film 4 composing the TFT 3 that is in the region directly below the pixel electrode 26a is connected electrically to the pixel electrode 26a. Consequently, also in Embodiment 3, it is possible to achieve the effect as described in Embodiment 1.

### INDUSTRIAL APPLICABILITY

As described above, according to the present invention, it is possible to suppress a reduction in picture quality of a display image in a liquid crystal display device. The liquid crystal display device of the present invention has industrial applicability.

1. A liquid crystal display device comprising an array substrate that includes a plurality of pixel electrodes and a plurality of active elements that drive the plurality of pixel electrodes,
wherein each of the plurality of active elements is arranged in a region directly below one of the pixel electrodes that is different from and adjacent to the pixel electrode to be driven thereby, and includes a silicon film provided with a diffusion layer, as well as a gate electrode provided on the silicon film via an insulating film, and
the silicon film is formed so as to range from a region directly below the pixel electrode to be driven by the active element composed of the silicon film to the region directly below the different pixel electrode, and a portion of the silicon film that is in the region directly below the pixel electrode to be driven by the active element is connected electrically to the pixel electrode to be driven by the active element.

2. The liquid crystal display device according to claim 1,
wherein the array substrate includes, on the silicon film, a second insulating film covering the insulating film and the gate electrode, as well as a resin layer covering the second insulating film, and the plurality of pixel electrodes are formed on the resin layer, and
the silicon film and the pixel electrode are connected electrically via a first conductive path penetrating the insulating film and the second insulating film, a second conductive path penetrating the resin layer, and a wiring provided on the second insulating film.

3. The liquid crystal display device according to claim 1, wherein sub-pixels including the pixel electrodes are arranged in a delta pattern.

4. The liquid crystal display device according to claim 1, wherein sub-pixels including the pixel electrodes are arranged in a stripe pattern.
